(19) United States
(12) Patent Application Publication
(10) Pub. No.: US 2022/0221616 A1
(43) Pub. Date: Jul. 14, 2022

(54) LANDFALLING EVENT ATMOSPHERIC RIVER NEURAL NETWORK (LEARN2) FORECAST TOOL

(71) Applicant: INNOVIM, LLC, Greenbelt, MD (US)

(72) Inventors: Philip ARDANUY, Greenbelt, MD (US); Sibren ISAACMAN, Greenbelt, MD (US); Justin HICKS, Greenbelt, MD (US); Ethan CARTON, Greenbelt, MD (US)

(21) Appl. No.: 17/572,534

(22) Filed: Jan. 10, 2022

Related U.S. Application Data
(60) Provisional application No. 63/135,455, filed on Jan. 8, 2021.

(51) Int. Cl. G01W 1/00; G06N 3/04

(52) U.S. Cl. CPC G01W 1/00; G06N 3/0454; G06N 3/0481

(57) ABSTRACT

The invention describes a new and improved weather forecasting model which utilizes neural networks to execute equations which use timed inputs from current weather forecasting models to produce more accurate weather predictions. By innovatively combining several independent techniques through Machine Learning (ML), the LEARN² decision support tool can improve heavy precipitation forecast skill in Week 1 and extend the duration of skillful forecasts two additional days into Week 2, as measured by accuracy and precision against verification observations—beyond that presently available from today's operational GFS and GEFS predictions alone. The LEARN² predictions, while based upon the precipitation and atmospheric field forecasts of the GFS or GEFS, add in three significant additional information sources: (1) remotely sensed satellite observations untainted by the data assimilation analyses conducted by NWP centers as a part of each forecast's initialization. While allowing the models to better assimilate the observations, there is an unavoidable loss of in-formation—information that these observed fields still retain; (2) sub-seasonal-to-seasonal (S2S) teleconnection indices, which pro-vide information on global circulation patterns that modulate synoptic meteorology; and (3) assessments of NWP model forecast biases, obtained from a sequence of forecasts and their verifications. Operational NWP models have inherent biases that must be removed either objectively or subjectively before use.

This invention was made with government support under 11.021 NOAA Small Business Innovation Research (SBIR) Program awarded by the U.S. Department of Commerce, National Oceanic and Atmospheric Administration. The government has certain rights in the invention.

### TECHNICAL FIELD

The present disclosure relates to weather forecasting systems.

### BACKGROUND OF THE INVENTION

The Nation's primary operational global Numerical Weather Prediction (NWP) models include the Global Prediction System (GFS) and the Global Ensemble Prediction System (GEFS). Each of these models is, at its heart, a set of dynamical and physical equations that require input data to produce weather predictions. The accuracy of the weather predictions is based on the completeness and resolution of the input data, the timeliness of the input data, the accuracy of the input data, and the accuracy of the equations used to predict future weather. We are all generally familiar with weather forecasting systems and their inability to accurately predict the weather. Over the years, the predictions from the then available weather forecasting systems have been improved, but there is still a long way to go before we can depend on weather forecasting models to provide reliable, accurate, dependable predictions—especially beyond the first seven days forecast into the second week of the forecast.

Generally, there are two different types of weather models, global models and regional models (also referred to as mesoscale models). Examples of global models include the GFS and the European Center for Medium-Range Weather Forecast (ECMWF) model. In general, regional models provide a higher resolution for a limited geographic area. Examples of regional models include the North American Model (NAM), Weather Research and Forecasting Model (WRF), and Rapid Refresh Model (RAP).

Currently there is also a National Blend of Models, which blends both National Weather Service and non-National Weather Service data and post-processed model guidance in an attempt to improve weather forecasts.

### SUMMARY OF THE INVENTION

The invention includes a method of predicting a timing and intensity of precipitation across a grid of points throughout a geographic area, where the method includes the steps of: using a first neural network to determine a first timing, and a first intensity of precipitation across the grid of points throughout the geographic area, using a second neural network to determine a second timing, and a second intensity of precipitation across the grid of points throughout the geographic area, using a meta-neural network to accept the first timing, and the first intensity across the grid of points from the first neural network and the second timing, and the second intensity across the grid of points throughout the geographic area from the second neural network, using a sigmoid activation function to calculate a first set of values for the first intensity and a second set of values for the second intensity across the grid of points throughout the geographic area, and combining the first set of values and the second set of values across the grid of points throughout the geographic area to produce a set of network outputs wherein said network outputs predict an amount of precipitation across the grid points throughout the geographic area.

### BRIEF DESCRIPTION OF THE DRAWINGS

The drawings are meant to illustrate the principles of the invention and do not limit the scope of the invention. The above-mentioned features and objects of the present disclosure will become more apparent with reference to the following description taken in conjunction with the accompanying drawings wherein like reference numerals denote like elements.

FIG. 1A illustrates a block diagram of a single layer neural network.

FIG. 1B illustrates a block diagram of a deep neural network, which is an artificial neural network (ANN) with multiple layers between the input and output layers.

FIG. 1C illustrates a block diagram of a wide neural network, which represents a network with a lesser number of hidden layers but a greater number of neurons per layer.

FIG. 1D illustrates a block diagram of a neural network with dense layers operating independently on each channel.

FIG. 1E illustrates a block diagram of a neural network with convolutional and pooling layers

FIG. 1F illustrates a block diagram of a neural network incorporating Long Short-Term Memory units.

FIG. 2 is an example architecture of a six-parallel neural networks which may be used to practice the invention.

FIG. 3 is an example flow chart illustrating the flow the neural network uses to produce the final result.

### DETAILED DESCRIPTION OF THE INVENTION

Reference will now be made in detail to the exemplary embodiments of the present disclosure, examples of which are illustrated in the accompanying drawings, wherein like reference numerals refer to like elements throughout. The embodiments are described below so as to explain the present disclosure by referring to the figures. Repetitive description with respect to like elements of different exemplary embodiments may be omitted for the convenience of clarity. The annotations included within the arrows which appear in the Figures generally are not relevant to the claimed invention.

Landfalling Event Atmospheric River Neural Network (LEARN²) is a novel, neural-network-based software tool used to augment the predictive ability of operational and research deterministic and ensemble numerical weather prediction (NWP) models, such as GFS and GEFS, to predict severe rainfall events. In this case, a neural network is a series of algorithms that are designed to recognize relationships in a set of data through a process that mimics weather patterns. Specifically, LEARN² is designed to predict the future existence of a potentially extreme land-falling atmospheric rivers (meaning narrow bands of enhanced water vapor transport) such that mitigations and planning may be conducted in advance of landfall. For example, these mitigations and planning may include the evacuations of people and property, reservoir water-level management, steps to minimize the damage from the anticipated weather, and similar preparations. LEARN² can also be used to forecast precipitation amounts within the geographic area.

Ideally, the system is composed of multiple independently running neural networks that ingest specifically chosen portions of the initial state and forecast fields, preferably combined with ancillary satellite-based analysis fields and sub-seasonal-to-seasonal climatological teleconnection indices. The predictions of these neural networks in combination with the future cumulative rainfall prediction of the model (e.g., GFS or GEFS) itself may then be run through a meta neural network resulting in a final prediction with a confidence interval. The meta neural network is an additional neural network that could more accurately weigh the votes of the initial networks.

Ideally, the GFS products ingested into the initial neural nets include: Temperature, Convergence, Vorticity, Geopotential Height, and either Total Precipitable Water (TPW) or Integrated Vapor Transport (IVT). The products ingested into the initial neural nets may be fewer than the examples provided, or it may include additional GFS products, or they may also include other weather related products or inputs. Currently, the example products are produced four times per day and all measurements may be included as may be the measurements for a fixed number of days of history. Thus, LEARN² can create a time series for each product using data from a selected latitude/longitude Pacific Ocean and adjacent regions of interest relative to the region for which the predictions are being made, the city, the county, or other geographic areas for which the prediction is to occur. Additionally, GFS predicted values for these products for a fixed (or variable) number of days into the future can be fed into LEARN². These model and satellite dataset can be concatenated with teleconnection and sub-seasonal indices including, for example, the El Nino/Southern Oscillation (ENSO) and the Madden Julian Oscillation (MJO).

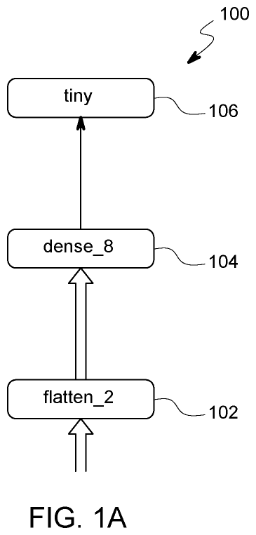

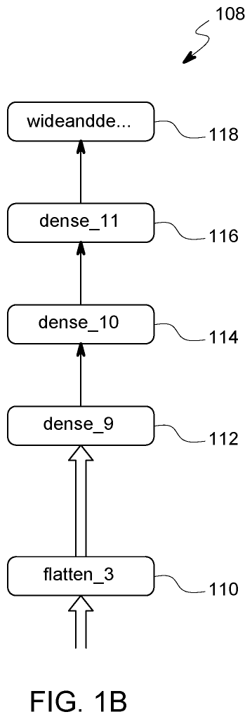

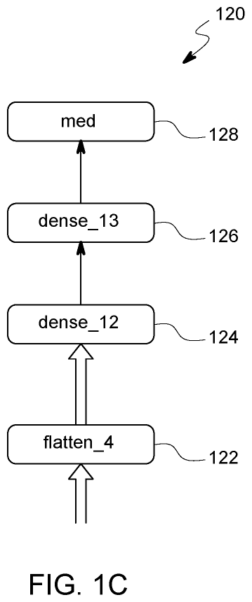

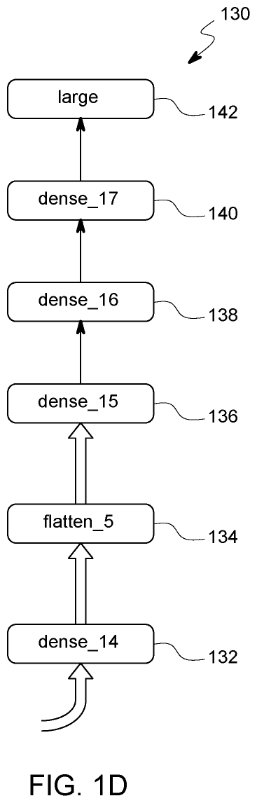

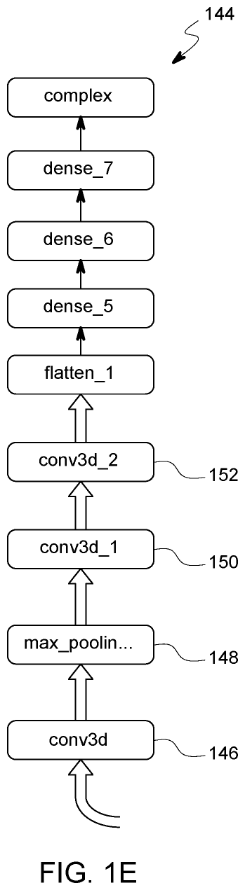

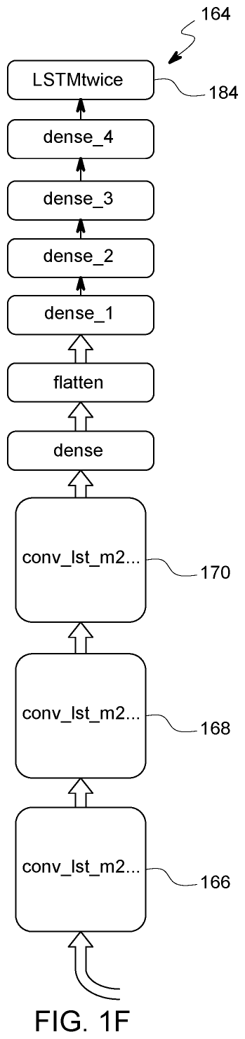

The neural networks (FIGS. 1A-F) into which the timeseries can be fed preferably include a three-dimensional (3D) convolutional neural network; a convolutional neural network with pooling layers, a long-short-term-memory neural network, and/or a deep, densely connected network. The set of models used in both the voting and meta-net schemes may be:

1. A single layer neural network

2. A deep neural network

3. A wide neural network

4. A neural network with dense layers operating independently on each channel.

5. A neural network with convolutional and pooling layers

6. A neural network incorporating Long Short-Term Memory units

Each of these models is briefly explained below. One of ordinary skill in the art would appreciate the characteristics, advantages, and disadvantages of each of these models.

FIG. 1A illustrates a block diagram of a single layer neural network 100, which represents the most-simple form of neural network, in which there is only one layer of input nodes that send weighted inputs to a subsequent layer of receiving nodes, or in some cases, one receiving node. The single layer neural network 100 of FIG. 1 includes an input (flatten_2) 102, processing (dense_8) 104, and an output (tiny) 106. It is just a basic single layer network. The major components of the networks are defined below:
flatten—reduces the dimensionality of the input from N to 1, preserving the order the data are stored in memory
dense—a fully connected layer implementing the operation output=activation_function (input*weight+bias)
max_pooling_3D—divides the hypercube into 3-dimensional blocks and replaces each 3-dimensional sub-cube with the maximum value of the sub-cube
conv_3d—performs a 3-dimensional convolution on the input with the learned 3-dimensional kernel
conv_1st_m—a recurrent layer performing the Long Short-Term Memory algorithm described by Hochreiter, S., & Schmidhuber, J. (1997). Long short-term memory. Neural computation, 9(8), 1735-1780. The input and recurrent transformations are convolutional over the 3D space
tiny, med, wideanddeep, large, complex, LSTMtwice—the 6 output layers of the 6 sub-networks, each layer is a single “dense” node as described above

FIG. 1B illustrates a block diagram of a deep neural network 108, which is an artificial neural network (ANN) with multiple layers 112, 114 and 116 between the input 110 and output 118 layers. There are different types of neural networks, but they always consist of the same components: neurons, synapses, weights, biases, and functions. This triples the depth of the simple network. Within an artificial neural network, a neuron is a mathematical function that models the functioning of a biological neuron. Typically, a neuron computes the weighted average of its input, and this sum is passed through a nonlinear function, often called activation function, such as the sigmoid. A synapse is the connection between nodes, or neurons. Weights control the signal (or the strength of the connection) between two neurons. In other words, a weight decides how much influence the input will have on the output. Biases, which are constant, are an additional input into the next layer that will always have the value of 1. Activation functions decide whether a neuron should be activated or not, and whether the information that the neuron is receiving is relevant for the given information or should it be ignored. The activation function is the non-linear transformation to the input signal before the transformed output is sent to the next layer of neurons as input.

FIG. 1C illustrates a block diagram of a wide neural network 120, which represents a network with a lesser number of hidden layers 124 and 126 but a greater number of neurons per layer. One of ordinary skill in the art would appreciate that FIG. 1C may include a large number of nodes in each of the layers, which could be multiple hundreds of nodes (˜256), as compared to the approximately 64 nodes that were in the other dense layers (See FIG. 1D), hence the “wide” description.

FIG. 1D illustrates a block diagram of a neural network with dense layers 130 operating independently on each channel; the dense layer is a neural network layer that is connected deeply, which means each neuron in the dense layer receives input from all neurons of its previous layer. Ideally, the dense layer 132 is positioned before the flatten layer 134, which is what supports the “dense layers operating independently on each channel” portion of the description. This neural network with dense layers 130 is configured to find inner-channel information before treating the incoming data as one block of data.

FIG. 1E illustrates a block diagram of a neural network 144 with convolutional 146, 150, 152, and pooling 148 layers; the pooling operation involves sliding a two-dimensional filter over each channel of feature map and summarizing the features lying within the region covered by the filter. Pooling layers are used to down sample the volume of convolution neural network by reducing the small translation of the features. Convolutional layers are the major building blocks used in convolutional neural networks. A convolution is the simple application of a filter to an input that results in an activation. Repeated application of the same filter to an input, results in a map of activations called a feature map, indicating the locations and strength of a detected feature in an input, such as an image. The innovation of convolutional neural networks is the ability to automatically learn a large number of filters in parallel specific to a training dataset under the constraints of a specific predictive modeling problem, such as image classification. The result is highly specific features that can be detected anywhere on input images. The convolutional layers are reference numbers 146, 150, 152; the pooling is layer 148. This network leverages cross-channel correlations. Here, a simple yet effective operator encourages information exchange across different channels at the same convolutional layer. This allows channels in each layer to communicate with each other before passing information to the next layer.

FIG. 1F illustrates a block diagram of a neural network 164 incorporating Long Short-Term Memory units 184. Long short-term memory (LSTM) 184 is an artificial recurrent neural network (RNN) architecture used in the field of deep learning. LSTM networks 184 are well-suited to classifying, processing, and making predictions based on time series data, since there can be lags of unknown duration between important events in a time series. The LSTM layers are actually combined with a convolution layer 166, 168, and 170 because of how Tensorflow—an open-source framework developed to run machine learning, deep learning and other statistical and predictive analytics workloads—does things. They are the first 3 layers of the network. This is the network that leverages the history portion of LEARN².

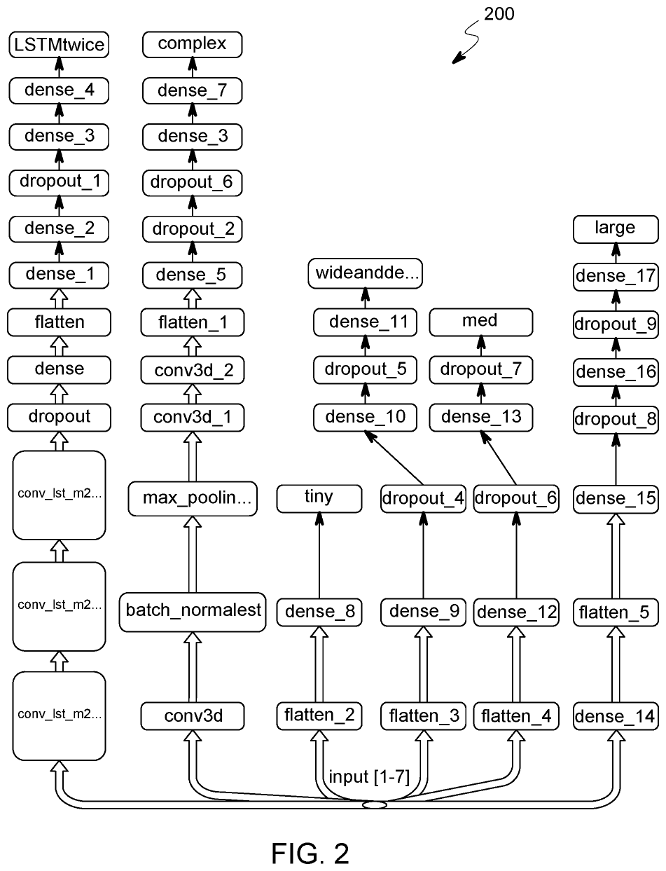

The predictions from these networks and the rainfall prediction of the GFS can be fed into either a final fully connected deep neural network or (to simplify computation) can simply be used to “vote” on the predicted rainfall severity. The system can be configured as a binary classifier but generalizes to multiple categories trivially. A second branch of the tool may allow for the multiple neural networks to collectively vote on the outcome, with the confidence of each model weighting each vote (ideally) via, for example, a sigmoid function, and the collective voting determining the daily, location-specific threshold-based rain/no-rain predictions. The input products may be stacked to make a 4D hypercube that may become the input to the neural network. The parallel neural networks may have an architecture as seen in FIG. 2. The outputs of the six neural nets (for example) may be used as the ‘x’ value in the sigmoid function (Equation 1). A sigmoid function is an “S-shaped” curve between values of y=0 and y=1, where values asymptote as they approach this maximum/minimum value. This function is defined by Equation 1.

$$S ( x ) = \frac{1}{1 + {e}^{- x}} \qquad Equation 1 \text{-} Sigmoid function$$

One of ordinary skill in the art would appreciate that other types of sigmoid functions could be used without departing from the invention.

FIG. 2 shows a possible architecture 200 of six parallel neural networks of LEARN². The upper layer is the hypercube of inputs (see FIGS. 1A-1F). The direction of the data flow in FIG. 2 is from the bottom of the figure to the top of the figure. In FIG. 2, the single hypercube of inputs can be passed into the bottom of each of the sub-networks as detailed in FIGS. 1A-1F. The sub-networks operate in parallel. Each layer of the neural network is depicted as taking the input from below, performing its operation, and then passing the data to the layer above it. The neural network concludes with, for example, six output nodes, one at the top of each branch representing a sub-network in the figure.

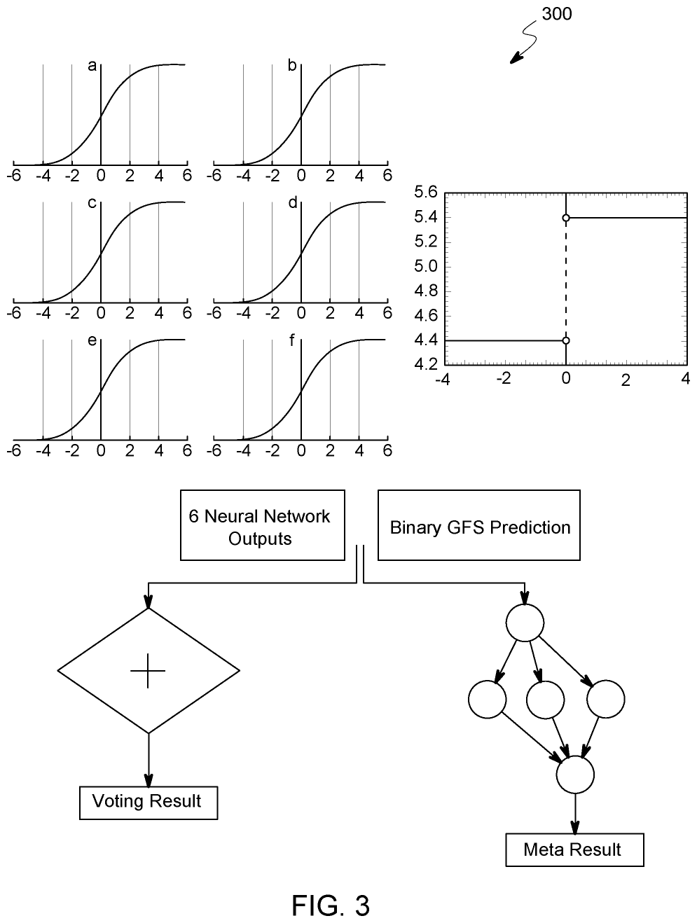

Two directions are now possible. When a voting mechanism is implemented, the results may be summed together with the binary GFS prediction. For example, if the sum is greater than 3.5 [i.e., 6 neural nets+1 GFS prediction)/2], the prediction may be for above-average precipitation (rainfall or snowfall). If the sum is less than 3.5, the prediction may be for less than average precipitation. In the meta-network implementation, the sigmoids and GFS or GEFS and other fields may be run through a final, densely connected neural network to produce the final result which is normalized through the sigma function to a value between 0 and 1. Any reading over 0.5 is a positive (high-precipitation) result. An example of this decision-making process is shown in FIG. 3.

FIG. 3 is an illustration of a possible final stage 300 of LEARN². Each of the sub-networks in the neural network are fitted to a sigmoid function. These six sigmoids are concatenated with the binary prediction made by the GFS or GEFS. The full suite of seven predictions are passed to two independent methods to make a final prediction. In the model depicted to the left of the figure (the “voting result”), the seven predictions are averaged to produce a final prediction. In the model depicted on the right (the “meta result”), the seven predictions are run through another neural network to produce the final prediction.

The LEARN² predictions, at present improving upon the precipitation and atmospheric field forecasts of the Global Forecast System (GFS) and Global Ensemble Prediction System (GEFS), the operational NWP forecast models produced by the National Centers for Environmental Prediction (NCEP), add in three significant additional information sources: (1) remotely sensed satellite observations untainted by the data assimilation analyses conducted by NWP centers as a part of each forecast's initialization. While allowing the models to better assimilate the observations, there is an unavoidable loss of information—information that these observed fields still retain; (2) S2S teleconnection indices, which provide information on global circulation patterns that modulate synoptic meteorology. Regional S2S modes can be even more influential than ENSO in modulating AR precipitation; and (3) assessments of NWP model forecast biases, obtained from a sequence of forecasts and their verifications. It is the innovative use of AI technologies in the LEARN² decision support framework that enables us to synergistically combinate all four of these information sources to achieve the enhanced predictive skill in Week 1, and extended skill into Week 2. Our technique mitigates, in part, the consequences of initial-state uncertainty through the application of synergistic AI techniques. Our extreme precipitation prediction technique can extract useful information from lower-skill forecasts, along with adaptation and refinement.

Our use of a leading AI technique, ML, confirmed significant potential for extreme precipitation forecasting and decision support value. Using Pacific Ocean domain, LEARN² successfully demonstrated and validated a robust decision support tool that can be used standalone or in concert with other skillful technologies with a viable path from research to operations.

Using the gradient-descent “loss minimization” training technique, not unlike minimization of RMS error, for the neural networks heightened the networks' “awareness” of and sensitivity to high-impact events—a highly desirable, even essential, feature. This is demonstrated through superior accuracy and precision metrics. It comes at the expense of lowered sensitivity to rainfall events that are close to the average-rainfall threshold.

LEARN² demonstrates the ability of AI/ML reanalysis to combine NWP, Sub-seasonal-to-Seasonal (S2S), and satellite observations. LEARN² allows the integration of dynamical NWP forecast guidance products with additional analyzed satellite observed fields to surpass the skill of GFS or GEFS alone in Week 1. LEARN² allows the post-processed integration of dynamical NWP forecast guidance products with climatological S2S teleconnection indices and allows the extension of skillful forecasts beyond Week 1 and well into Week 2. LEARN² quantified the reliance of AI/ML for prediction of infrequent (heavy rainfall) events on training with an adequate number of events, requiring many years of data, or data augmentation

Ideally, built with a modular framework, the LEARN² architecture typically allows continuous development as the state of the art in weather data and machine learning advances. Due to the use of loosely coupled modules (an approach to designing interfaces across modules to reduce the interdependencies across modules or components—in particular, reducing the risk that changes within one module will create unanticipated changes within other modules), each subsystem, the data preprocessing node and the prediction node, are easily updated or even replaced live without interruption to the customer facing service. These subsystems may be interfaced by an enterprise service bus, which is horizontally scalable, and may keep a record of all data processed by each node. This record can be used to quickly train new models, to look back on and understand mistakes, and to keep this living system up to date with the latest advancements in the field.

Unless defined otherwise, all technical terms used herein have the same meaning as commonly understood by one of ordinary skill in the art to which this invention belongs. Any methods and materials similar or equivalent to those described herein also can be used in the practice or testing of the present disclosure

It must be noted that as used herein and in the appended claims, the singular forms “a”, “and”, and “the” include plural references unless the context clearly dictates otherwise.

While the present disclosure has been described with reference to the specific embodiments thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present disclosure. All such modifications are intended to be within the scope of the claims appended hereto.

1. A method of predicting a timing and an intensity of precipitation across a grid of points throughout a geographic area, said method including the steps of:
using a first neural network to determine a first timing, and a first intensity of precipitation across said grid of points throughout said geographic area,
using a second neural network to determine a second timing, and a second intensity of precipitation across said grid of points throughout said geographic area,
using a meta-neural network to accept said first timing, and said first intensity across said grid of points from said first neural network and said second timing, and said second intensity across said grid of points throughout said geographic area from said second neural network,
using a sigmoid activation function to calculate a first set of values for said first intensity and a second set of values for said second intensity across said grid of points throughout said geographic area, and
combining said first set of values and said second set of values across said grid of points throughout said geographic area to produce a set of network outputs wherein said network outputs predict an amount of precipitation across said grid points throughout said geographic area.

2. The method of claim 1, further including training at least one of said neural networks through the use of at least one of the following types of data: NWP model weather analyses, future field prediction forecasts, predicted rainfalls, sub-seasonal indices, seasonal indices, and data from satellite observations.

3. The method of claim 1 wherein said first neural network is one of:
a single layer neural network, a deep neural network, a wide neural network, a neural network with dense layers operating independently on each channel, a neural network with convolutional and pooling layers, or a neural network incorporating Long Short-Term Memory units.

4. The method of claim 1 wherein said second neural network is one of:
a single layer neural network, a deep neural network, a wide neural network, a neural network with dense layers operating independently on each channel, a neural network with convolutional and pooling layers, or a neural network incorporating Long Short-Term Memory units.

5. The method of claim 1 further including the step of displaying said set of network outputs on a map of said geographic area.

6. The method of claim 1 wherein said precipitation is rainfall.

7. The method of claim 6 wherein said set of network outputs includes up to 14 days of predicted rainfall throughout said geographic area.

8. The method of claim 6 wherein one of updated GFS, GEFS, satellite, and teleconnection data are ingested at least once per day.

9. The method of claim 1 further including at least two confidence categories.

10. The method of claim 1 further including displaying a human readable interpretation of said network outputs.

11. The method of claim 1 further including the ability of a user to define said user's own meaningful criteria.

12. The method of claim 1 further including the step of automatically ingesting data required and automatically sending out network outputs.

13. The method of claim 1 wherein one of said neural networks can be replaced without affecting any other neural network.
